(19) United States
(12) Patent Application Publication
(10) Pub. No.: US 2018/0261137 A1
(43) Pub. Date: Sep. 13, 2018

(54) THREE-DIMENSIONAL LIGHT BOX

(71) Applicant: Ledyoung Technology Corporation, Taoyuan City (TW)

(72) Inventor: Yen-Chou HSU, Taoyuan City (TW)

(21) Appl. No.: 15/456,571

(22) Filed: Mar. 12, 2017

(51) Int. Cl. G09F 13/10; F21V 8/00; G09F 13/04

(52) U.S. Cl. CPC G09F 13/10; G09F 13/0413; G02B 6/005

(57) ABSTRACT

A three-dimensional light box includes a light source including a light guide panel and a light-emitting device for emitting light into the light guide panel, and a signboard including multiple signboard sheet members arranged in a stack on the light-emitting surface of the light guide panel. Each signboard sheet member includes a positioning sheet made of a light-emitting material and a picture layer coated on the positioning sheet. When the light-emitting device emits light through the light guide panel and the signboard, the picture layers of the signboard sheet members create a sense of three-dimensional hierarchy.

### BACKGROUND OF THE INVENTION

### 1. Field of the Invention:

The present invention relates to signboard technology and more particularly, a three-dimensional light box, which comprises a light source, and a signboard formed of a stack of signboard sheet members for creating a sense of three-dimensional hierarchy when the light source emits light through the signboard.

### 2. Description of the Related Art:

A regular advertising light box mainly comprises a housing, a signboard mounted in the housing, and light source mounted in the housing for emitting light through the signboard to highlight the advertising content so as to attract people's eyes and to achieve the effect of soliciting business and customers. However, the signboards of conventional advertising light boxes are simply a single layer sheet or panel bonded or printed with an advertizing content or picture, showing a different style of design. However, the composition of the advertizing content or picture is simply a planar design that cannot create a sense of three-dimensional hierarchy, is easy to make the visual sensory feel dull. Moreover, because the aforesaid conventional advertising light box has only one single advertising panel, it cannot create visual differences in different view angles, and thus, the effect of this conventional design of advertising light box is more monotonous

### SUMMARY OF THE INVENTION

The present invention has been accomplished under the circumstances in view. It is therefore the main object of the present invention to provide a three-dimensional light box, which creates a sense of three-dimensional hierarchy when it is turned on to emit light.

To achieve this and other objects of the present invention, a three-dimensional light box comprises a light source and a signboard. The light source comprises a light guide panel, and a light-emitting device for emitting light into the light guide panel. The signboard comprises a plurality of signboard sheet members arranged in a stack on the light-emitting surface of the light guide panel. Each signboard sheet member includes a positioning sheet made of a light-emitting material and a picture layer coated on the positioning sheet. Thus, when the light-emitting device emits light through the light guide panel and the signboard, the picture layers of the signboard sheet members create a sense of three-dimensional hierarchy.

Preferably, the three-dimensional light box further comprises an outer frame that holds the light source and the signboard therein.

Preferably, the signboard further comprises a spacer sheet or cushion block mounted between each two adjacent signboard sheet members. The spacer sheet or cushion block is made of a light-transmitting material.

Preferably, the outer frame comprises a plurality of mounting grooves extending around an inner perimeter thereof. Further, the light source and the signboard sheet members of the signboard are respectively peripherally positioned in the mounting grooves of the outer frame.

### BRIEF DESCRIPTION OF THE DRAWINGS

FIG. 1 is a sectional elevational view of a three-dimensional light box in accordance with a first embodiment of the present invention.

FIG. 2 is an exploded view of the three-dimensional light box in accordance with a first embodiment of the present invention.

FIG. 3 is an exploded view of a three-dimensional light box in accordance with a second embodiment of the present invention.

FIG. 4 is an exploded view of a three-dimensional light box in accordance with a third embodiment of the present invention.

FIG. 5 is a sectional elevational view of a three-dimensional light box in accordance with a fourth embodiment of the present invention.

FIG. 6 is an exploded view of the three-dimensional light box in accordance with the fourth embodiment of the present invention.

### DETAILED DESCRIPTION OF THE PREFERRED EMBODIMENT

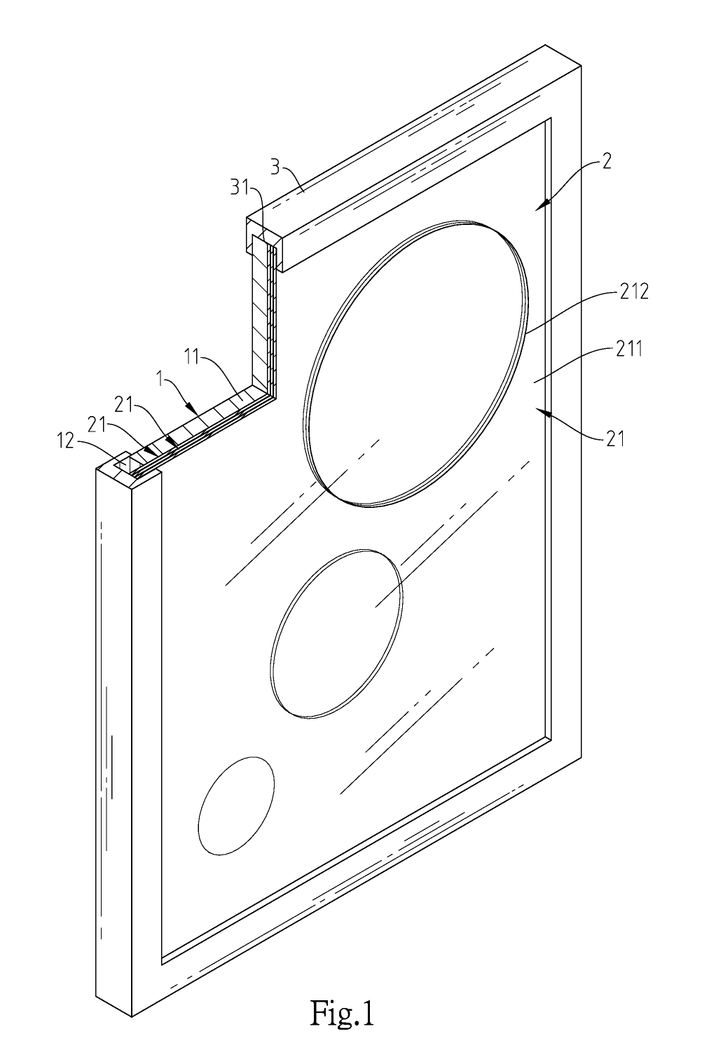

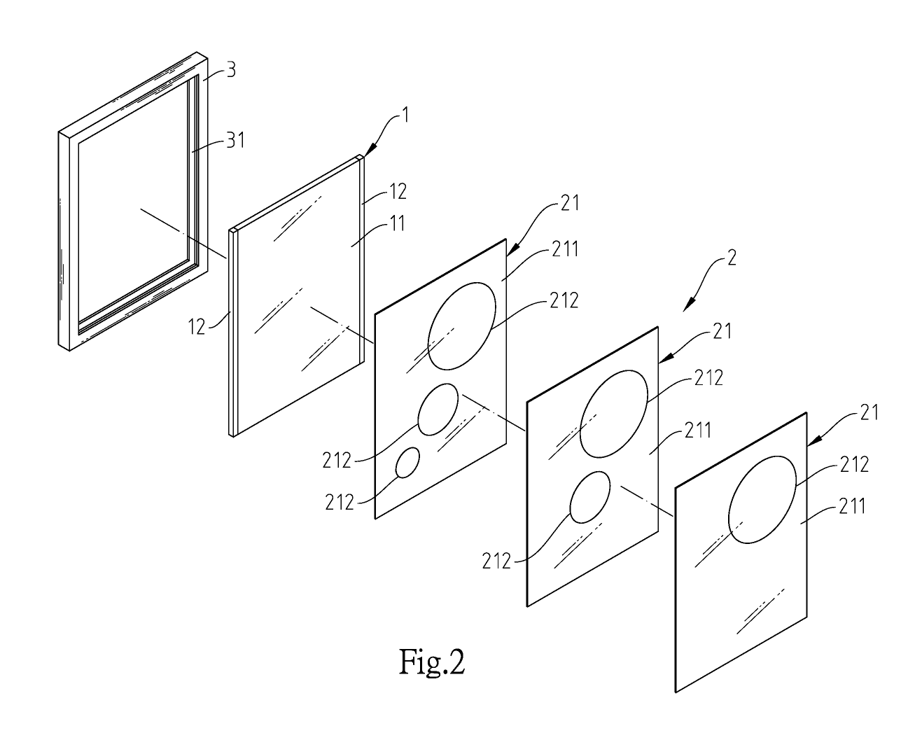

Referring to FIGS. 1 and 2, a three-dimensional light box in accordance with a first embodiment of the present invention is shown. The three-dimensional light box comprises a light source 1, a signboard 2 and an outer frame 3.

The light source 1 comprises a light guide panel 11, and a light-emitting device 12 arranged around the light guide panel 11 and adapted for emitting light into the light-emitting device 12, enabling the emitted light to be distributed in the light guide panel 11 and guided out of a light-emitting surface of the light guide panel 11.

The signboard 2 comprises a plurality of signboard sheet members 21. Each signboard sheet member 21 comprises a positioning sheet 211 and a picture layer 212 coated on the surface of the positioning sheet 211. Further, the positioning sheet 211 is made of a light-transmitting material. The multiple signboard sheet members 21 are stacked up and arranged on the surface of the light guide panel 11 of the light source 1.

The outer frame 3 defines therein a mounting groove 31. The light source 1 and the signboard 2 are peripherally mounted in the mounting groove 31 of the outer frame 3.

Thus, in the use of the three-dimensional light box, the light emitted by the light source 1 goes through the signboard 2 toward the outside. Since the picture layers 212 of the signboard 2 are spaced from one another by the positioning sheets 211 in front-back direction, a sense of hierarchy is created, achieving three-dimensional visual effects. When viewing from different angles, different visual effects will be produced.

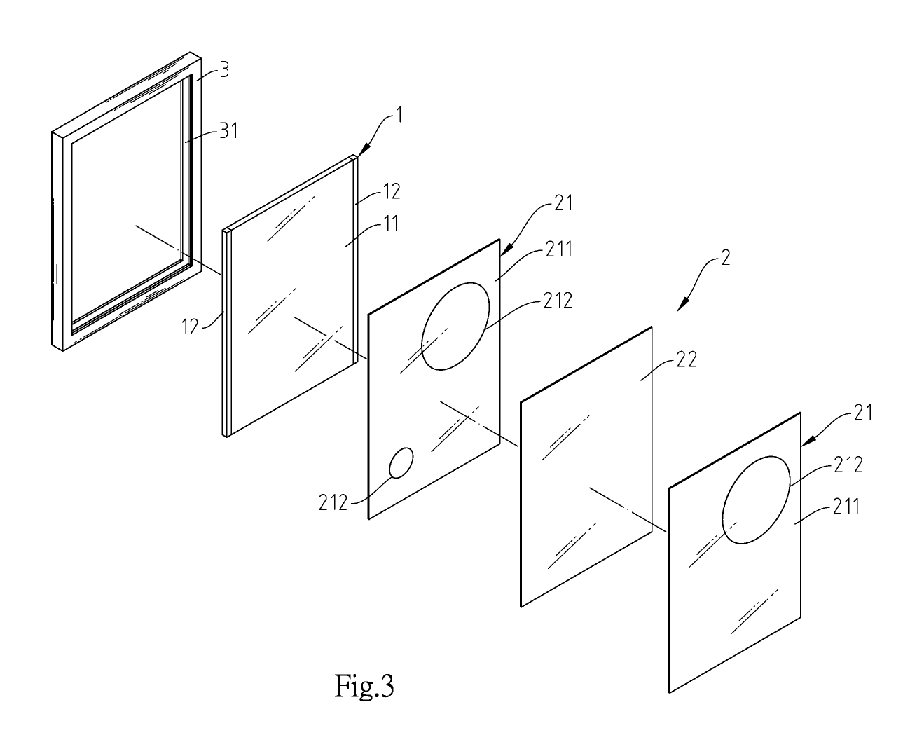

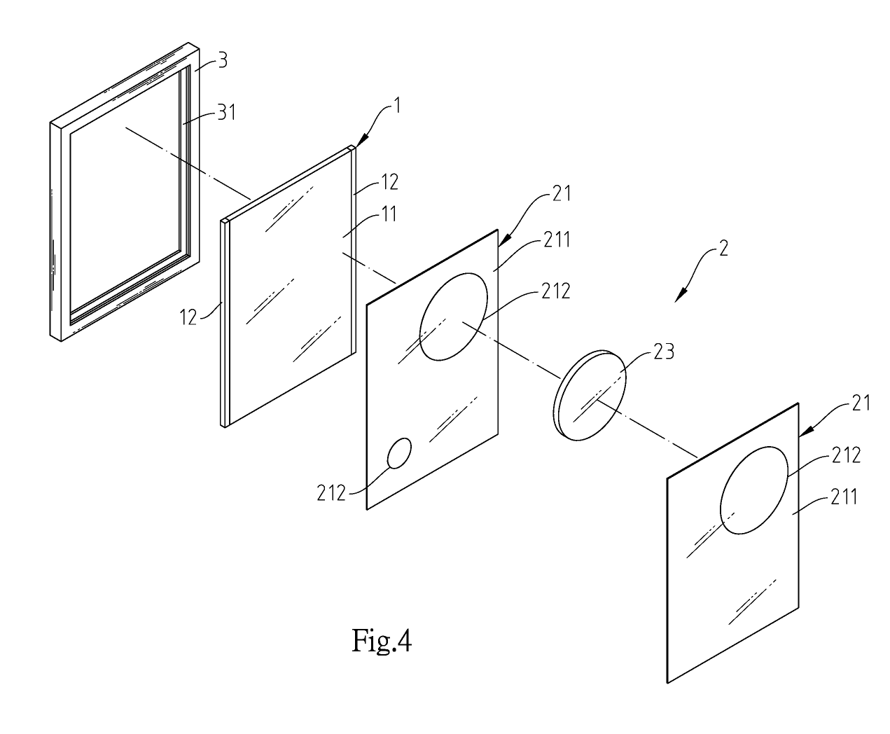

Referring to FIGS. 3 and 4, a three-dimensional light box in accordance with a second embodiment of the present invention and a three-dimensional light box in accordance with a third embodiment of the present invention are shown. In the embodiment shown in FIG. 3, the signboard 2 comprises a plurality of signboard sheet members 21, and a spacer sheet 22 set between each two adjacent signboard sheet members 21. The spacer sheet 22 is made of a light-transmitting material. Subject to the arrangement of the spacer sheet 22 between each two adjacent signboard sheet members 21, the signboard sheet members 21 are kept from one another at a distance, enhancing the sense of hierarchy. In the third embodiment shown in FIG. 4, a cushion block 23 is arranged between each two adjacent signboard sheet members 21. The cushion block 23 is made of a light-transmitting material. Further, the cushion block 23 can be positively positioned between the respective two adjacent signboard sheet members 21 using an adhesive or any other fastening means. Subject to the arrangement of the cushion block 23 between each two adjacent signboard sheet members 21, the signboard sheet members 21 are kept from one another at a distance, enhancing the sense of hierarchy. However, in actual application, one or multiple cushion blocks 23 can be arranged between each two adjacent signboard sheet members 21. Further, the cushion blocks 23 can be made in any of a variety of shapes, for example, in the shape of a character.

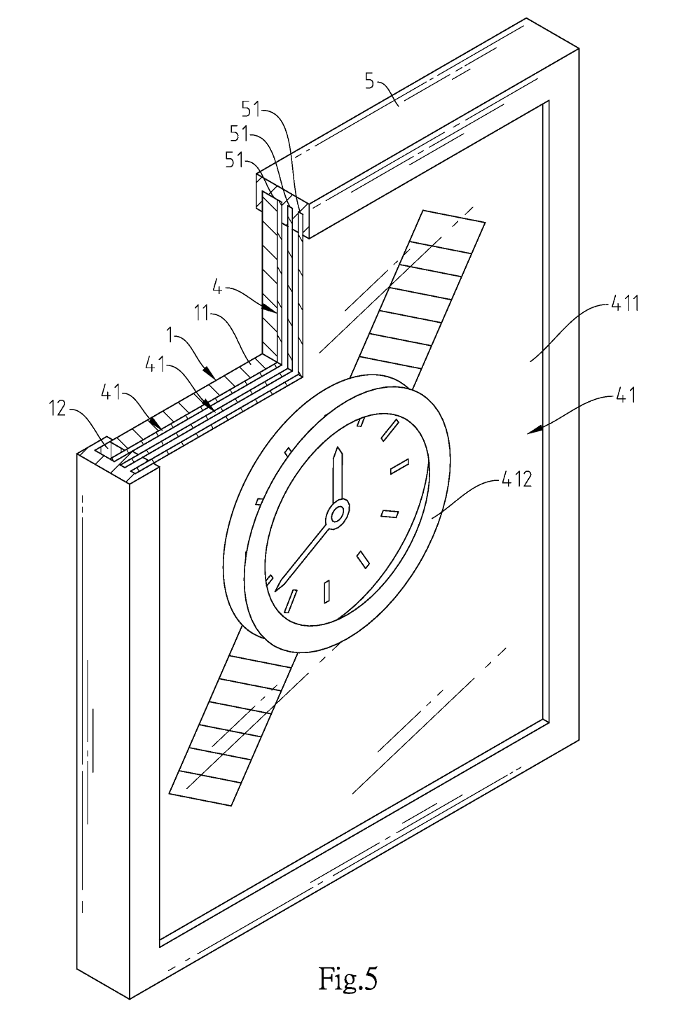

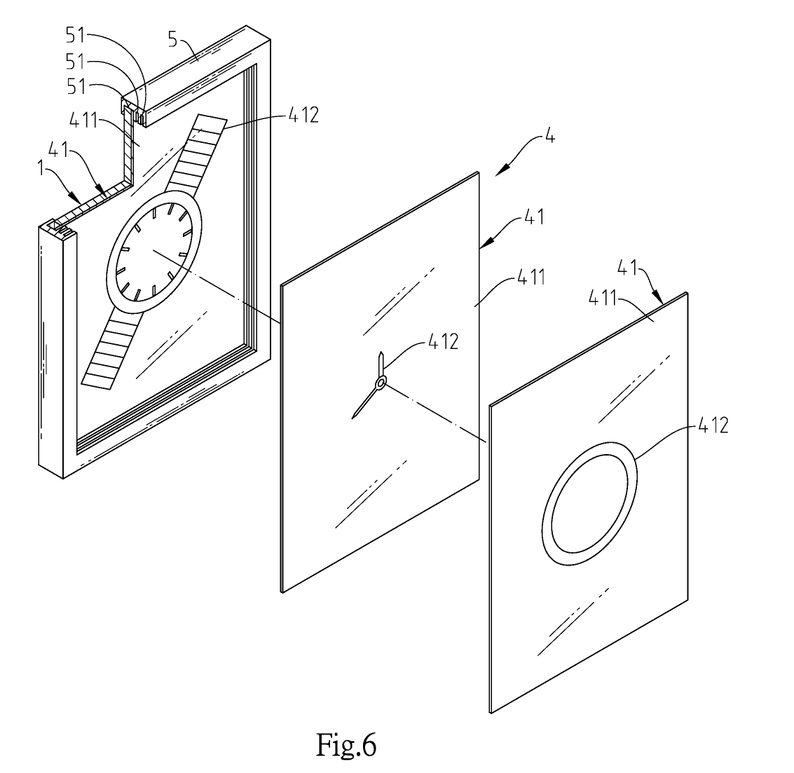

Referring to FIGS. 5 and 6, a three-dimensional light box in accordance with a fourth embodiment of the present invention is shown. According to this fourth embodiment, the three-dimensional light box comprises a light source 1, a signboard 4 and an outer frame 5. The outer frame 5 comprises a plurality of mounting grooves 51 extending around an inner perimeter thereof. The signboard 4 comprises a plurality of signboard sheet members 41. Each signboard sheet member 41 comprises a positioning sheet 411 and a picture layer 412 coated on the surface of the positioning sheet 411. The light source 1 and the signboard sheet members 41 of the signboard 4 are peripherally positioned in the respective mounting grooves 51 he outer frame 5. Subject to the arrangement of the mounting grooves 51, the signboard sheet members 41 are kept apart from one another, increasing the distance between each two picture layers 412 and enhancing the sense of hierarchy. Further, the picture layers 412 of the signboard sheet members 41 respectively exhibit the shape of a watch case, the shape of a set of hands and the shape of a bezel. Thus, when the signboard sheet members 41 are arranged together, the picture layers 412 exhibit the shape of a complete watch. When viewing the signboard 4, you can see the picture of a three-dimensional watch, improving your ad performance.

What is claimed is:

1. A three-dimensional light box, comprising:
a light source, said light source comprising a light guide panel and a light-emitting device configured to emit light into said light guide panel, and
a signboard mounted on a light-emitting surface of said light guide panel light source and illuminated by said light source through said light guide panel, wherein:
said signboard comprises a plurality of signboard sheet members, each said signboard sheet member comprising a positioning sheet and a picture layer disposed on said positioning sheet, the positioning sheets of said signboard sheet members being made of a light-transmitting material, and
the plurality of signboard sheet members are stacked together to form a stack of signboard sheet members, and the signboard comprising the stack of signboard sheet members is disposed on the light-emitting surface of the light guide panel so that the said picture layers of the stack of signboard sheet members creates a sense of three-dimensional appearance when said light-emitting device emits light through said light guide panel and said the stack of signboard sheet members.

2. The three-dimensional light box as claimed in claim 1, further comprising an outer frame holding said light source and said signboard therein.

3. The three-dimensional light box as claimed in claim 1, wherein said stack of signboard sheet members further comprises a spacer sheet mounted between each two adjacent said signboard sheet members, said spacer sheet being made of a light-transmitting material.

4. The three-dimensional light box as claimed in claim 1, wherein said stack of signboard sheet members further comprises a cushion block mounted between each two adjacent said signboard sheet members, said cushion block being made of a light-transmitting material.

5. The three-dimensional light box as claimed in claim 1, further comprising an outer frame holding said light source and said signboard therein, said outer frame comprising a plurality of mounting grooves extending around an inner perimeter thereof; said light source and the said signboard sheet members of said signboard are respectively peripherally positioned in said mounting grooves of said outer frame.
